(19) United States
(12) Patent Application Publication
(10) Pub. No.: US 2020/0236424 A1
(43) Pub. Date: Jul. 23, 2020

(54) AUDIO TUNING PRESETS SELECTION

(71) Applicant: Hewlett-Packard Development Company, L.P., Spring, TX (US)

(72) Inventors: Sunil BHARITKAR, Palo Alto, CA (US); Maureen Min-Chaun LU, Taipei (TW)

(21) Appl. No.: 16/487,897

(22) PCT Filed: Apr. 28, 2017
(86) PCT No.: PCT/US2017/030153

§ 371 Date: Aug. 22, 2019

(51) Int. Cl. H04N 21/439; H04N 21/435; H04N 21/485; H04L 29/06

(52) U.S. Cl. CPC H04N 21/4394; H04N 21/435; H04L 65/4069; H04L 65/60; H04N 21/4852

(57) ABSTRACT

In some examples, audio tuning presets selection may include determining whether content included in a transport stream includes stereo content or multichannel content by analyzing components of the content included in the transport stream, and a duration of the content included in the transport stream. In response to a determination that the content included in the transport stream includes the stereo content, a stereo content preset may be applied to the content included in the transport stream. Alternatively, in response to a determination that the content included in the transport stream includes the multichannel content, a multichannel content preset may be applied to the content included in the transport stream.

### BACKGROUND

Devices such as notebooks, desktop computers, mobile telephones, tablets, and other such devices may include speakers or utilize headphones to reproduce sound. The sound emitted from such devices may be subject to various processes that modify the sound quality.

### BRIEF DESCRIPTION OF DRAWINGS

Features of the present disclosure are illustrated by way of example and not limited in the following figure(s), in which like numerals indicate like elements, in which:

FIG. 1 illustrates an example layout of an audio tuning presets selection apparatus;

FIG. 2 illustrates an example graphical user interface of device consumer selectable presets;

FIG. 3 illustrates an example layout of a Moving Picture Experts Group (MPEG)-2 transport stream for terrestrial and satellite;

FIG. 4 illustrates an example layout of an MPEG2 transport stream for Internet Protocol television;

FIG. 5 illustrates an example MPEG2 transport stream for Internet Protocol television;

FIG. 6 illustrates an example of MPEG2 transport stream multiplexing video, audio, and program information via a Program Map table;

FIG. 7 illustrates an example MPEG2 transport stream Program Map table;

FIG. 8 illustrates an example of MPEG2 transport stream Advanced Audio Coding-Audio Data Transport Stream;

FIG. 9 illustrates an example MPEG2 transport stream Program Map table with audio stream types identifying cinematic content;

FIG. 10 illustrates an example content classifier;

FIG. 11 illustrates an example of audio decoder element values indicating number of channels;

FIG. 12 illustrates an example of MPEG Advanced Audio Coding based bitstream syntax;

FIG. 13 illustrates an example of MPEG Advanced Audio Coding based channel configurations;

FIG. 14 illustrates an example of MP-4 metadata;

FIG. 15 illustrates an example of average duration of movie content along with some specific movies;

FIG. 16 illustrates an example distribution of a video length;

FIG. 17 illustrates examples of distribution of various genres in seconds;

FIG. 18 illustrates an example block diagram for audio tuning presets selection;

FIG. 19 illustrates an example flowchart of a method for audio tuning presets selection; and

FIG. 20 illustrates a further example block diagram for audio tuning presets selection.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Audio tuning presets selection apparatuses, methods for audio tuning presets selection, and non-transitory computer readable media having stored thereon machine readable instructions to provide audio tuning presets selection are disclosed herein. The apparatuses, methods, and non-transitory computer readable media disclosed herein provide for identification of stereo or multichannel content, as well as differentiation between stereo music and downmixed cinematic content (e.g., downmixed from 5.1 to stereo). In this regard, cinematic content may be multichannel (e.g., 5.1, 7.1, etc., where 5.1 represents “five point one” and includes a six channel surround sound audio system, 7.1 represents “seven point one” and includes an eight channel surround sound audio system, etc.). The identification of stereo or multichannel content may provide for the correct preset to be applied depending on the type of content, without the need for consumer intervention. Additionally, a separate preset may be applied to enhance speech or dialog clarity based on detection of voice in Voice over Internet Protocol (VoIP), or voice in cinematic content.

With respect to audio tuning, personal devices including loudspeakers may need to be tuned or calibrated in order to reduce the effects of loudspeaker and/or room acoustics, while also maximizing the quality of experience (QoE) for content involving audio or speech. Depending on the type of content being listened to, the tuning (viz., the type of preset and the corresponding value of the preset) may need to be applied correctly. For example, with music being stereo (e.g., 2-channels), a device may allow for bass, mid-range, and treble frequency control presets depending on device capability. In the case of cinematic content, which may be, for example, 5.1 channels (or next-generation object-based), it is technically challenging to determine a different set of presets to control various elements of the cinematic mix reproduced on personal devices. For example, a device may include a preset type that is the same for both music and cinematic/movie content, as if both were stereo audio content, whereas the actual values assigned to those presets may be different.

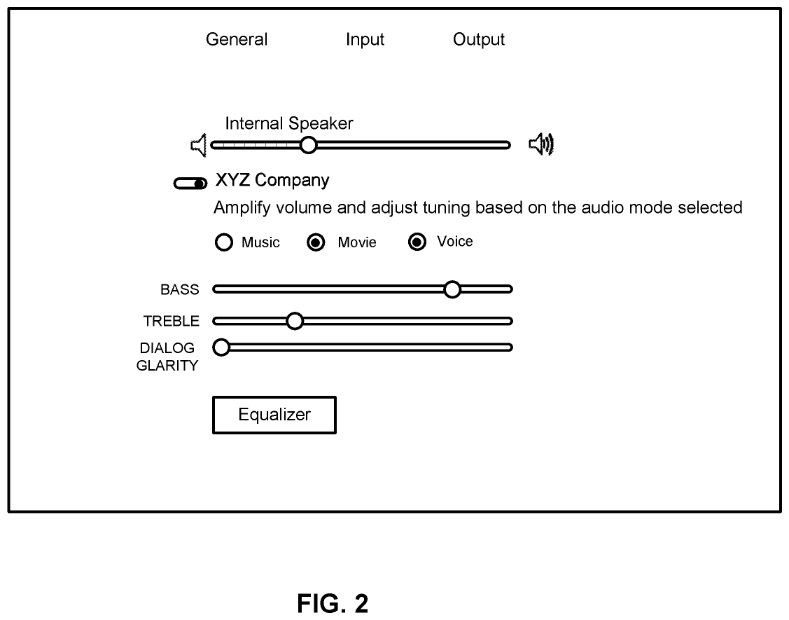

In devices such as all-in-one computers, desktops, etc., an interface may be provided for a consumer to select one of three pre-programmed (i.e., tuned) presets from movie, music, and voice. FIG. 2 illustrates an example graphical user interface of device consumer selectable presets. Referring to FIG. 2, the graphical user interface may include XYZ company tuning that is implemented, for example, as a Windows Audio processing object (APO), and may not be readily discernible to a consumer. Even if the consumer is aware, the consumer may need to manually apply the correct preset each time to the appropriate content. This process may be error-prone due to factors such as consumer unawareness, whether the consumer remembers to apply the correct preset, application of the wrong preset by the consumer to a particular type of content, etc. These aspects may degrade the desired quality of experience.

In order to address at least these technical challenges associated with determination of a different set of presets to control various elements of a cinematic mix reproduced on personal devices, and application of a correct preset to appropriate content, the apparatuses, methods, and non-transitory computer readable media disclosed herein provide for identification of stereo or multichannel content, as well as differentiation between stereo music (with or without video) and stereo downmixed cinematic content (downmixed from 5.1 to stereo). This identification provides for the correct preset to be applied depending on the type of content, without the need for consumer intervention, at a reference playback level. Further, based on the detection of voice in VoIP (or cinematic content where voice is in the center channel), a voice preset may be applied to enhance speech or dialog clarity. Yet further, a modified voice preset may be applied to microphone-captured speech based on detection of a keyword, where a preset may be used for enhancing the speech formant peaks and widths and adding specific equalization, compression, speech-rate change, etc.

For the apparatuses, methods, and non-transitory computer readable media disclosed herein, modules, as described herein, may be any combination of hardware and programming to implement the functionalities of the respective modules. In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

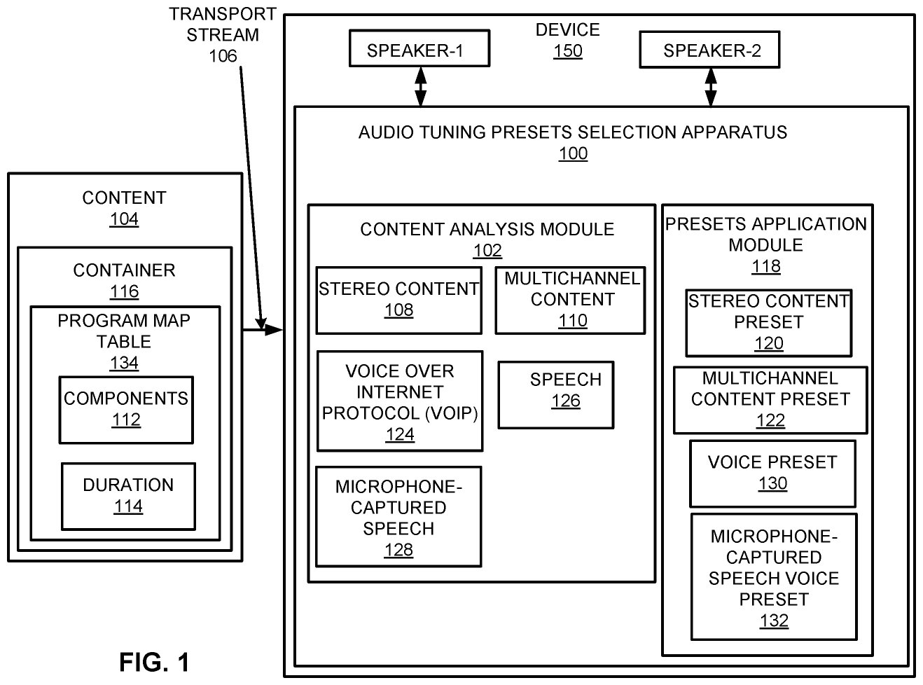

FIG. 1 illustrates an example layout of an audio tuning presets selection apparatus (hereinafter also referred to as “apparatus 100”).

In some examples, the apparatus 100 may include or be provided as a component of a device such as a notebook, a desktop computer, a mobile telephone, a tablet, and other such devices. For the example of FIG. 1, the apparatus 100 is illustrated as being provided as a component of a device 150, which may include a notebook, a desktop computer, a mobile telephone, a tablet, and other such devices.

Referring to FIG. 1, the apparatus 100 may include a content analysis module 102 to determine whether content 104 included in a transport stream 106 includes stereo content 108 or multichannel content 110 by analyzing components 112 of the content 104 included in the transport stream 106, and a duration 114 of the content 104 included in the transport stream 106. The components 112 of the content 104 included in the transport stream may be included in a container 116 included in the transport stream 106. For example, the presentation timestamp (PTS) metadata field may be extracted at the beginning and at the end of the content, and the difference in the timestamps may be used to determine the duration of the content. The presentation timestamp may represent the exact time that a frame needs to display. The presentation timestamp may be determined from streams, such as MPEG-2, MPEG-4 or H.264 streams. Video, audio, and data in the same program stream may use the same base time. Therefore, the synchronization between channels in the same program stream may be achieved by using this time stamp.

In response to a determination that the content 104 included in the transport stream includes the stereo content 108, a presets application module 118 is to apply a stereo content preset 120 to the content 104 included in the transport stream 106. Alternatively, in response to a determination that the content 104 included in the transport stream 106 includes the multichannel content 110, the presets application module 118 is to apply a multichannel content preset 122 to the content 104 included in the transport stream 106.

According to an example, the content analysis module 102 is to determine whether the stereo content 108 includes a video, whether the stereo content 108 does not include the video, and whether the stereo content 108 is downmixed cinematic content. In response to a determination that the stereo content 108 includes the video, that the stereo content 108 does not include the video, or that the stereo content 108 is downmixed cinematic content, the presets application module 118 is to apply a corresponding type (e.g., from types related to video, no video, and downmixed cinematic content) of the stereo content preset 120 to the content 104 included in the transport stream 106.

According to an example, the content analysis module 102 is to determine whether the content 104 included in the transport stream 106 includes voice in Voice over Internet Protocol (VoIP) 124, or speech 126. In response to a determination that the content 104 included in the transport stream 106 includes the voice in VoIP 124, or the speech 126, the presets application module 118 is to apply a voice preset 130 to the content 104 included in the transport stream 106.

According to an example, the content analysis module 102 is to determine whether the content 104 included in the transport stream 106 includes microphone-captured speech 128. In response to a determination that the content 104 included in the transport stream 106 includes the microphone-captured speech 128, the presets application module 118 is to apply a microphone-captured speech voice preset 132 to the content 104 included in the transport stream 106.

According to an example, the content analysis module 102 is to determine, based on the analysis of the components 112 in a Program Map table 134 included in the container 116, whether the content 104 included in the transport stream 106 includes audio content, or audio and video content. The components 112 may include audio frames for the audio content. Further, in response to a determination that the content 104 included in the transport stream 106 includes the audio content, or the audio and video content, the presets application module 118 is to selectively apply the stereo content preset 120 or the multichannel content preset 122 to the content 104 included in the transport stream 106.

According to an example, the content analysis module 102 is to determine, based on the analysis of the components 112 in the Program Map table 134 included in the container 116, whether the content 104 included in the transport stream 106 includes audio content, or audio-for-video content. In response to a determination that the content 104 included in the transport stream 106 includes the audio content, or the audio-for-video content, the presets application module 118 is to selectively apply the stereo content preset 120 or the multichannel content preset 122 to the content 104 included in the transport stream 106.

According to an example, the content analysis module 102 is to determine the duration 114 of the content 104 included in the transport stream 106 by analyzing a file-size and a data rate associated with the content 104 included in the transport stream 106. In this regard, the data rate may include a constant bitrate or a variable bitrate. Further, the content analysis module 102 is to analyze the duration 114 of the content 104 included in the transport stream 106 by comparing the duration 114 to predetermined durations for different types of stereo content and multichannel content.

With respect to detection of content type, the content analysis module 102 may rely on audio decoder, video decoder, transport stream and/or container file-format being used to extract or decode audio (e.g., no video) or audio/video content.

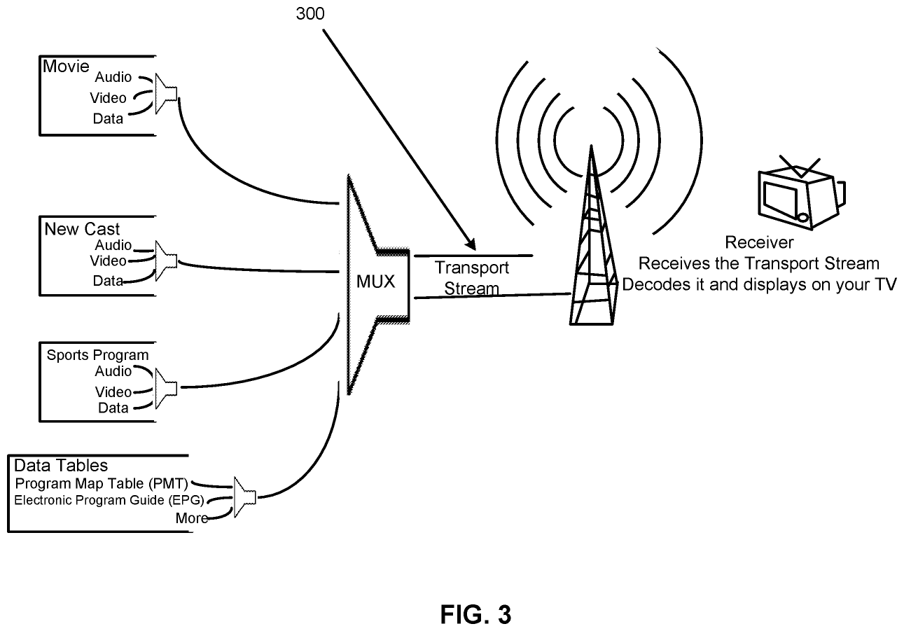

FIG. 3 illustrates an example layout of a Moving Picture Experts Group (MPEG)-2 transport stream for terrestrial and satellite.

Referring to FIG. 3, FIG. 3 includes an example of how various signals may be transported using a transport stream 300, for example, using terrestrial/satellite broadcast scenario. For the example of FIG. 3, the transport stream 300 may include the MPEG-2 transport stream which is a format internationally standardized in International Organization for Standardization (ISO)/MPEG.

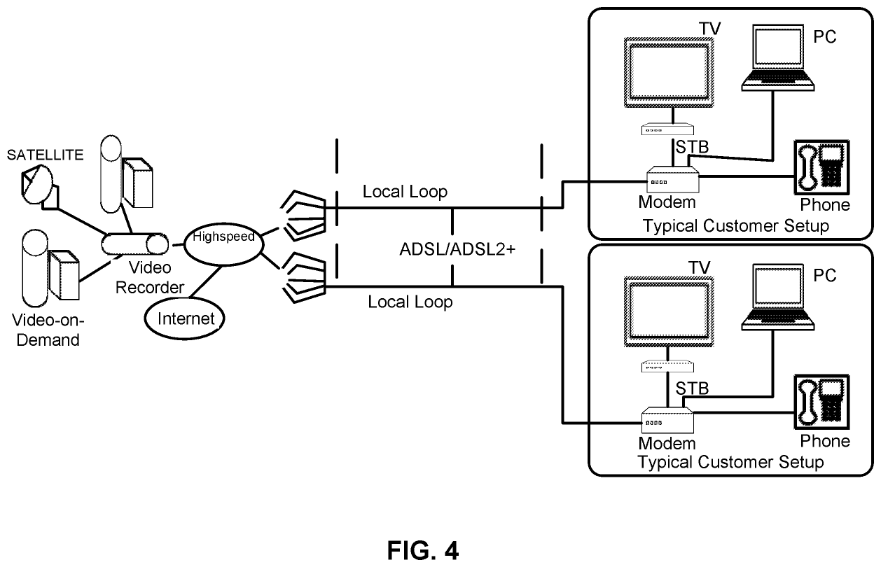

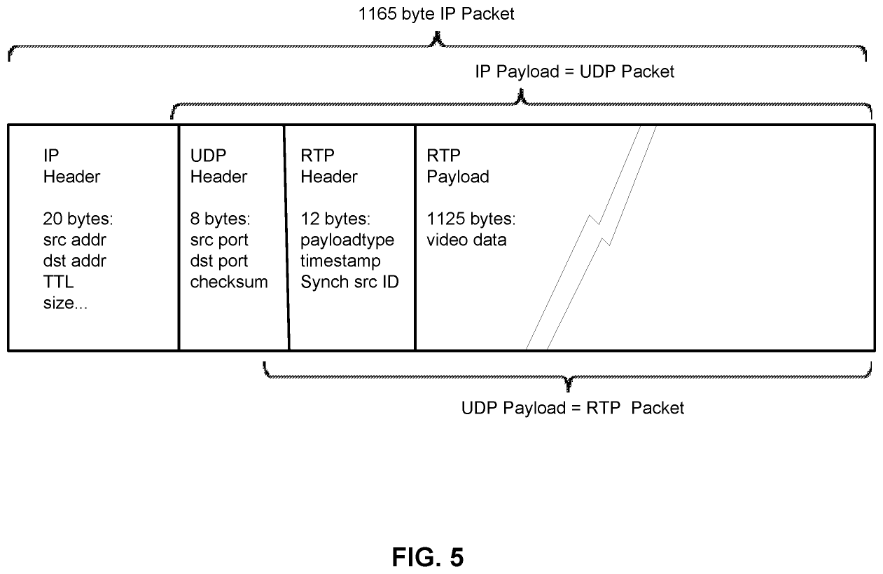

FIG. 4 illustrates an example layout of an MPEG2 transport stream for Internet Protocol television. Further, FIG. 5 illustrates an example MPEG2 transport stream for Internet Protocol television.

With respect to FIGS. 4 and 5, in the streaming or progressive download case over the Internet or cable, the delivery of audio/video may be implemented via a container file format (e.g., MPEG-4, avi, mkv, mov etc.). These containers may be incorporated in a transport stream for delivery over IPTV as depicted in FIGS. 4 and 5.

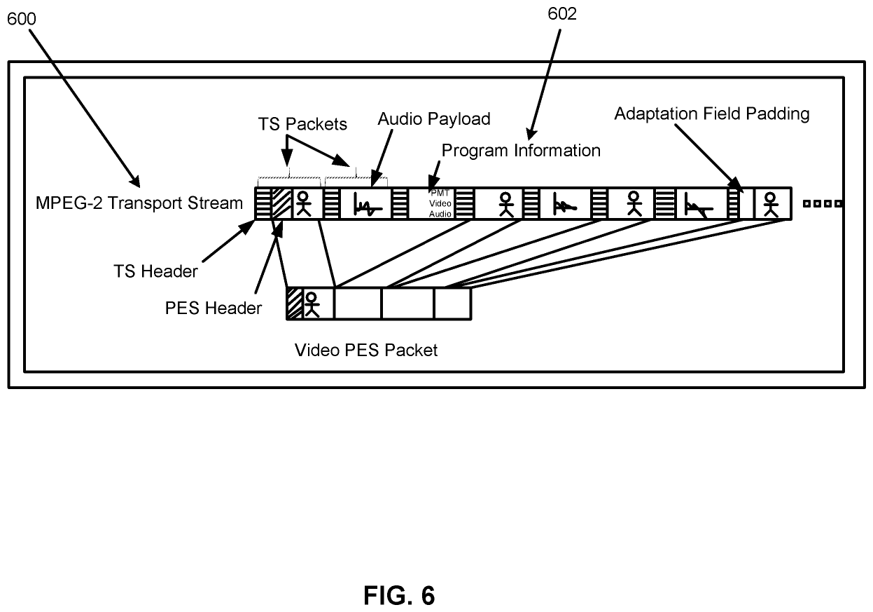

FIG. 6 illustrates an example of MPEG2 transport stream multiplexing video, audio, and program information via a Program Map table.

Referring to FIG. 6, an example of an MPEG2 transport stream 600 over Internet Protocol (IP) bitstream is illustrated, and depicts the Program Map table 602 in the stream.

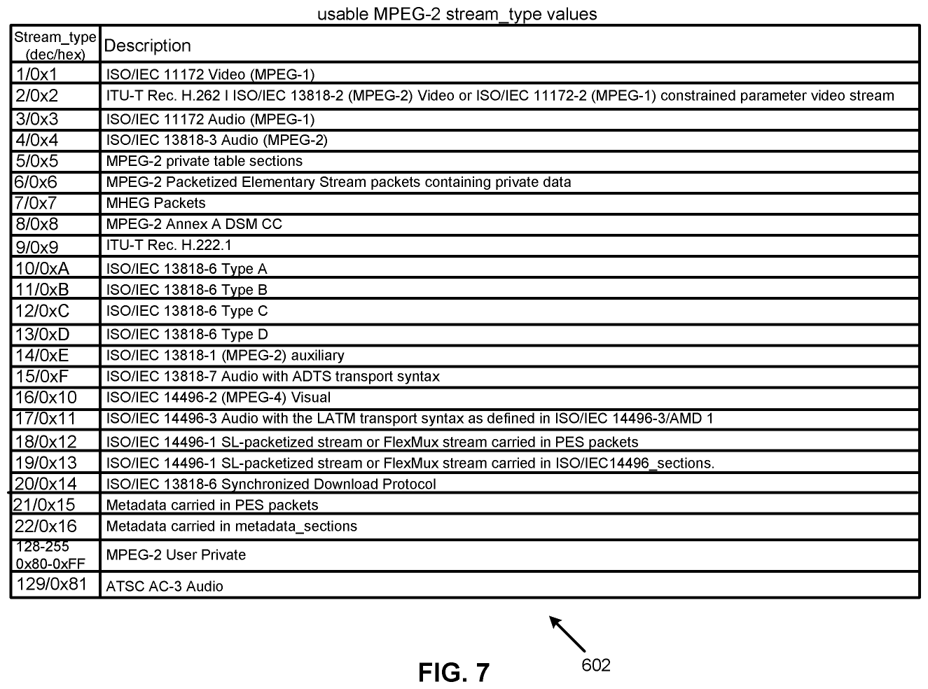

FIG. 7 illustrates an example MPEG2 transport stream Program Map table.

Referring to FIG. 7, FIG. 7 illustrates the Program Map table 602 from which content may be detected as either audio (i.e., non-a/v) or audio/video (i.e., a/v).

The transport stream may include four program specific informational tables that include Program Association Table (PAT), the Program Map table 602, Conditional Access Table (CAT), and Network Information Table (NIT). The Program Map table 602 may include information with respect to the program present in the transport stream, including the program number, and a list of the elementary streams that comprise the described MPEG-2 program. The Program Map table 602 may include locations for descriptors that describe the entire MPEG-2 program, as well as a descriptor for each elementary stream. Each elementary stream may be labeled with a stream type value. FIG. 7 shows various stream type values stored in the Program Map table 602. If the stream involves audio (e.g., music, but no video), this may be detected via the audio frames that may be included in Audio Data Transport Stream (ADTS) (stream type: 15/0xF), described, for example, by ISO International Electrotechnical Commission (IEC) 13818-7.

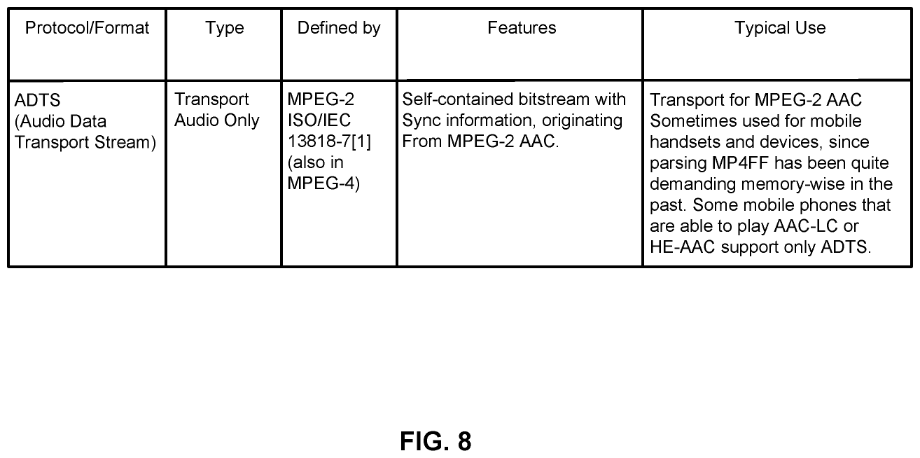

FIG. 8 illustrates an example of MPEG2 transport stream Advanced Audio Coding-Audio Data Transport Stream.

Referring to FIG. 8, a snapshot of ADTS from MPEG standard is shown in FIG. 8 where the audio sync information is ascertained from the audio data and not from an audio/video sync timestamp (as in video-based audio) content. Advanced Audio Coding (AAC) based coding may represent a standard for data compression of music signals. Accordingly, ADTS may be used to discriminate between audio (e.g., music, but no video) and audio-for-video (non-audio). Additionally, stream type (2/0x2H) may be used to validate the video being present in the program (corresponding to music-video, TV show, or cinematic content for example). Thus the Program Map table 602 may be used to discriminate between audio (e.g., music, but no video) in ADTS or audio-for-video (e.g., moving images).

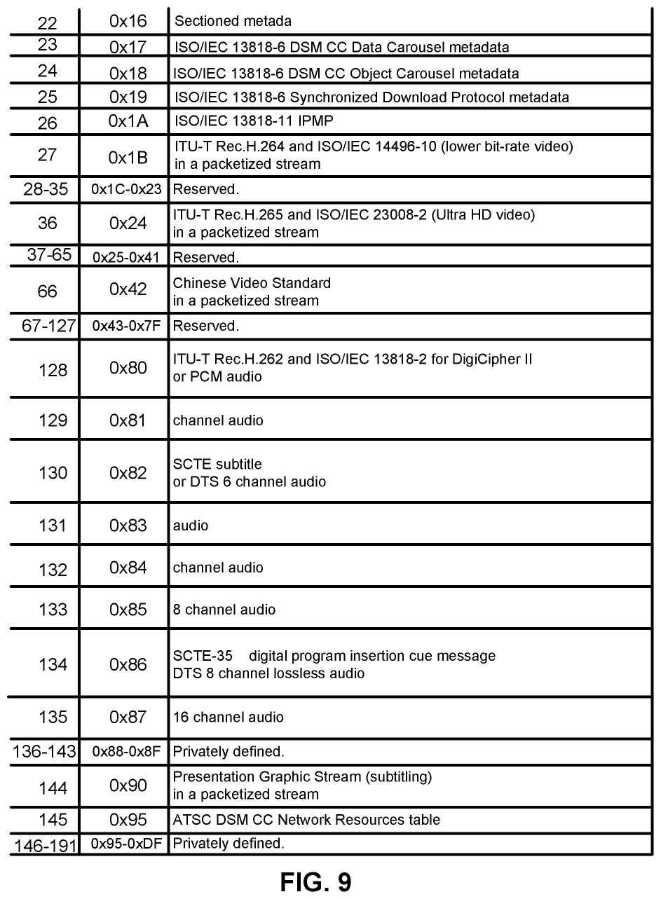

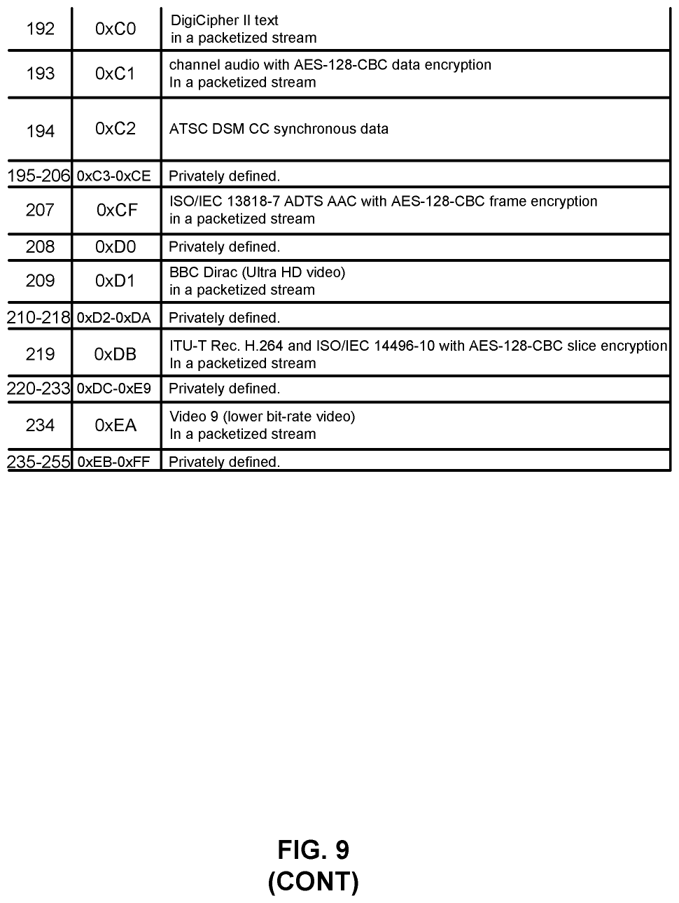

FIG. 9 illustrates an example MPEG2 transport stream Program Map table with audio stream types identifying cinematic content.

Referring to FIG. 9, identifiers for cinematic content (e.g., content either streamed or delivered through an external player) are shown in FIG. 9 through audio element stream types (e.g., 128-194).

With respect to an audio-for-video program, an audio-for-video program may not be a movie (e.g., the audio-for-video program may be a television show in stereo or a music-video in stereo). Accordingly, heuristics may be applied under such conditions to extract additional program information from program metadata (e.g., duration of the audio-for-video program). The file-size and data rate may also be used to derive the duration of the program from the video or audio coding approach (e.g., H.264, H.265, AC-3, Advanced Audio Coding (AAC), etc.) depending on whether constant bitrate or variable bitrate coding is used. For example, for constant bitrate and variable bitrate coding, the duration (e.g., d in seconds) may be determined from audio coding as follows:

$$\begin{matrix}{d}_{CBR} = \frac{filesize \times 8}{bitrate} & Equation ( 1 ) \\ {d}_{VBR} = \frac{N \times F}{{f}_{s}} & Equation ( 2 )\end{matrix}$$

For Equations (1) and (2), N may represent the number of frames, F may represent samples/frame, fₛ may represent the sampling frequency, filesize may be in kB (Kilobytes), and the bitrate may be in kbps (kilobits per sec). For cinematic clips, English movies may be 90 minutes or more, whereas television programs may not generally extend beyond 30 minutes, and music videos may be on an average approximately 4-5 minutes. Accordingly, downmixed cinematic content may be discriminated from television shows and music-videos. Additionally, a discriminant analysis (e.g., linear or pattern recognition techniques such as deep learning) may be applied to classify the content based on duration and the stream type data.

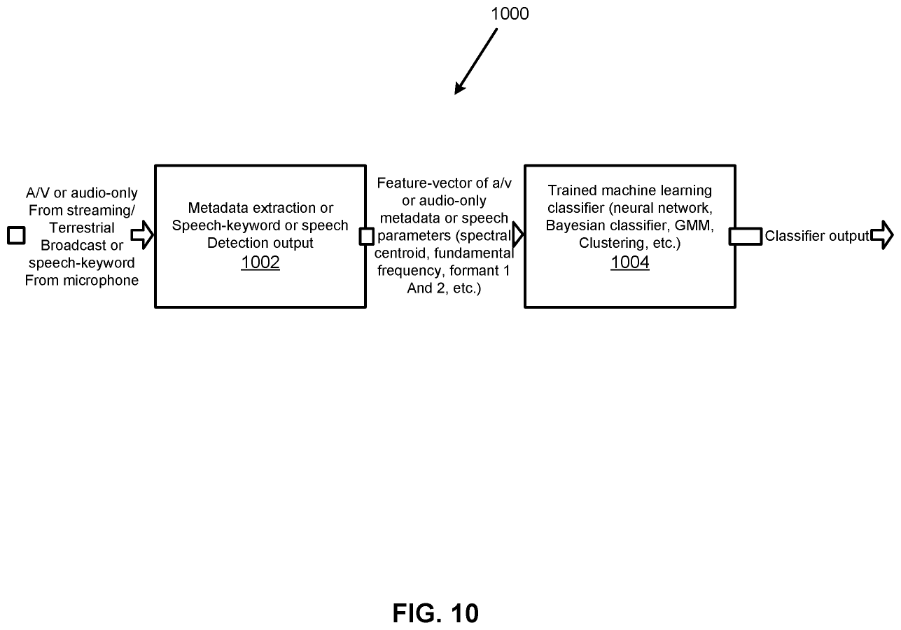

For example, FIG. 10 illustrates an example content classifier 1000.

Referring to FIG. 10, at block 1002, the content classifier 1000 may receive audio-video or audio from streaming or a terrestrial broadcast, or speech-keyword from a microphone. At block 1002, the content classifier 1000 may extract metadata, speech-keyword, or speech detection.

At block 1004, the content classifier 1000 may receive feature-vector of audio-video or audio metadata, or speech parameters (e.g., spectral centroid, fundamental frequency, formant 1 and 2, etc.). At block 1004, the content classifier 1000 may include a trained machine learning classifier (e.g., neural network, Bayesian classifier, Gaussian mixture model (GMM), clustering, etc.) to classify the content based on duration and the stream type data.

With respect to container formats (e.g., MP4 (MPEG-4), etc.), these formats may also be used for streaming over IP and hold both coded video and audio data. Since these formats may not be limited to storing audio data, these formats may be applicable for separating stereo (or downmixed cinematic audio) from multichannel cinematic audio using the techniques disclosed herein with respect to MP-2 transport stream. In this regard, the audio decoder parameters in the container may be analyzed to discriminate between multichannel audio and stereo content.

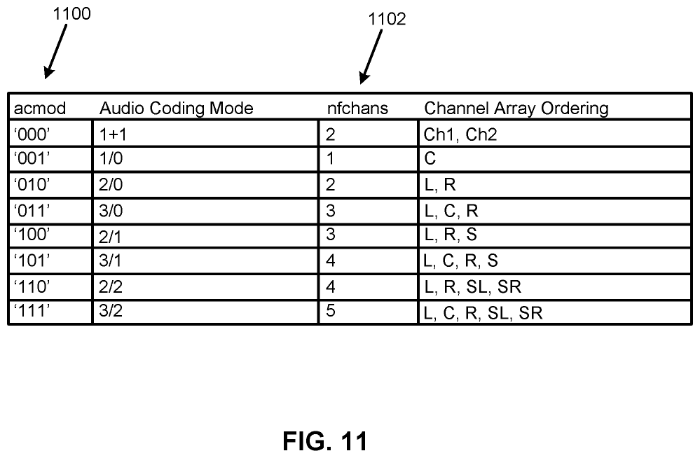

FIG. 11 illustrates an example of audio decoder element values indicating number of channels.

Referring to FIG. 11, an example of AC-3 information is shown via the AC-3 standard associated with the Advanced Television Systems Committee (ATSC). With respect to FIG. 11, the bitstream element at 1100 may identify the number of channels at 1102.

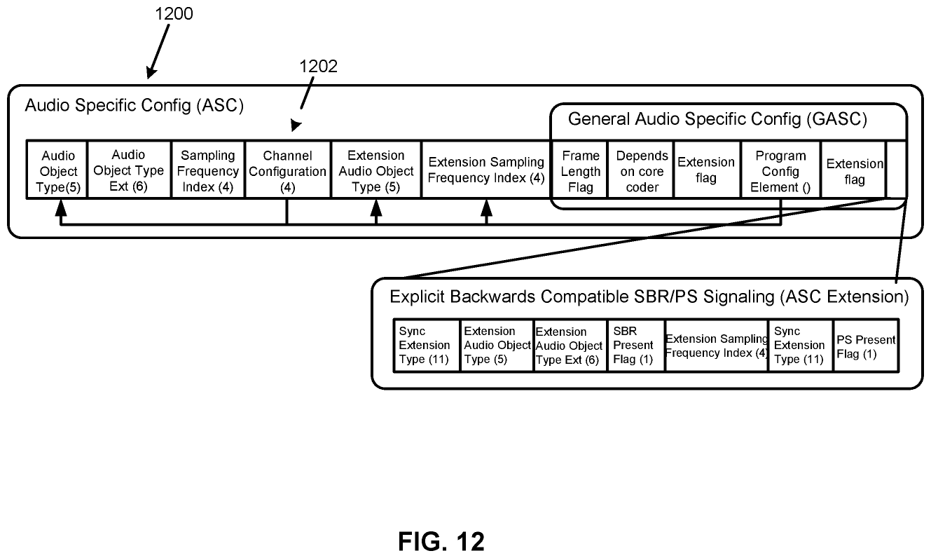

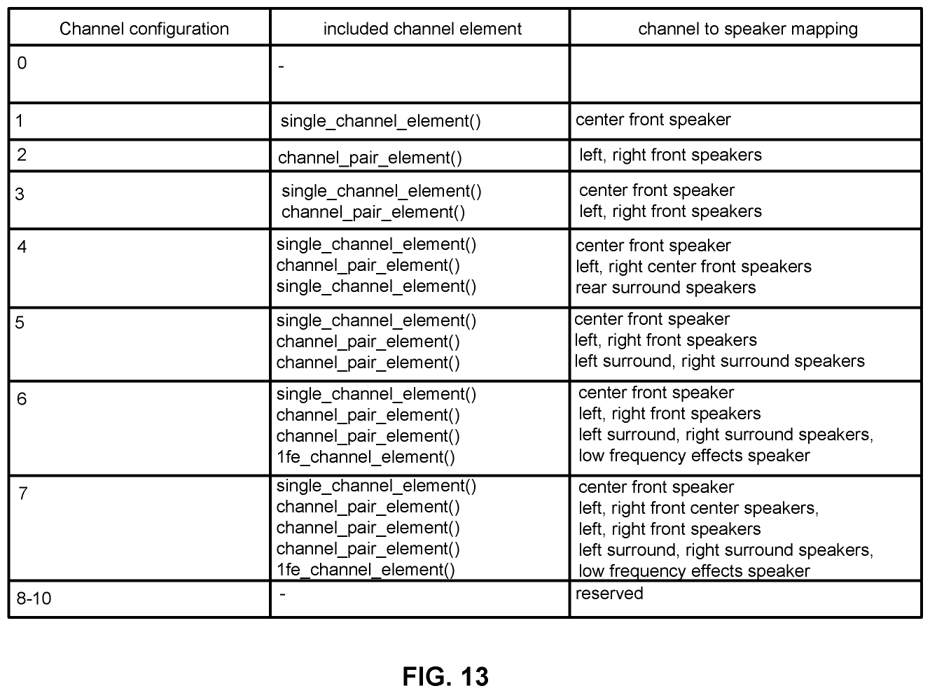

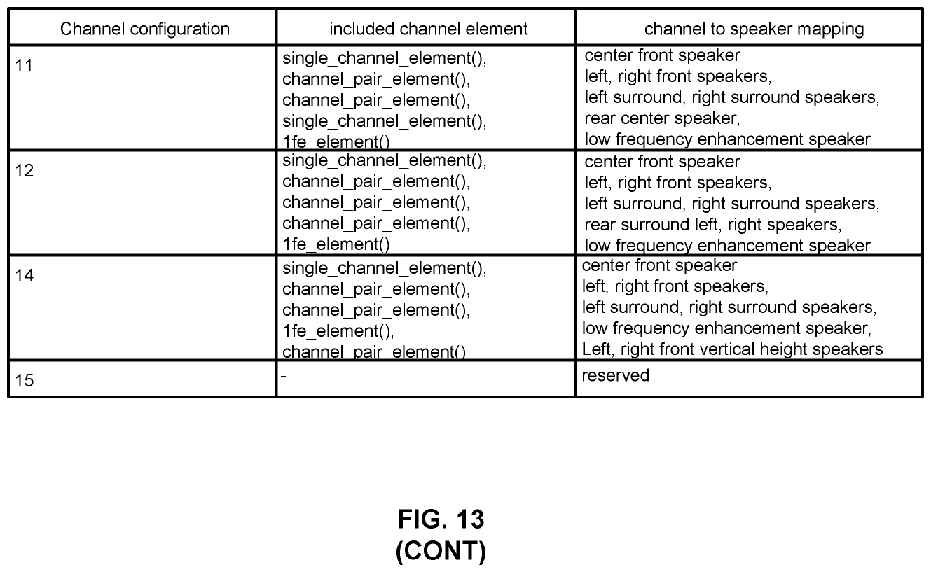

FIG. 12 illustrates an example of an MPEG Advanced Audio Coding based bitstream syntax. Further, FIG. 13 illustrates an example of MPEG Advanced Audio Coding based channel configurations.

Referring to FIG. 12, an example of Advanced Audio Coding (AAC) based audio coding channel modes, also used for encoding cinematic content or sports/broadcast content, is shown in FIG. 12. Specifically, FIG. 12 illustrates the bitstream syntax 1200 where four bits (16 possible channel configurations) may be allocated to the channel configuration syntax at 1202 in the bitstream of audio specific configuration (ASC). In this regard, FIG. 13 illustrates an example of MPEG Advanced Audio Coding based channel configurations. With respect to FIG. 12, the containers may also include duration of the media embedded as metadata, and this metadata may reside in the header for streaming or progressive download. During audio encoding, additional parameters may be employed to determine the type of content. For example, cinematic and other audio with video content may use 48 kHz sampling frequency, whereas music may be sampled at 44.1 kHz. The bit-depth used for cinematic content may include 24 bits/sample representation, whereas broadcast content (including sports) may use 20 bits/sample, and whereas music may use 16 bits/sample representations.

According to an example, an MPEG-4 (MP4) may need to be packaged in a specific type of container, with the format for this container following the MPEG-4 Part 12 (ISO/IEC 14496-12) specification. Stream packaging may be described as the process of making a multiplexed media file known as muxing, which combines multiple elements that enable control of the distribution delivery process into a single file. Some of these elements may be represented in self-contained atoms. An atom may be described as a basic data unit that contains a header and a data field. The header may include referencing metadata that describes how to find, process, and access the contents of the data field, which may include, for example, video frames, audio samples, interleaving AV data, captioning data, chapter index, title, poster, user data, and various technical metadata (e.g., coding scheme, timescale, version, preferred playback rate, preferred playback volume, movie duration, etc.).

In an MPEG-4 compliant container, every movie may include a {moov} atom. A movie atom may include a movie header atom (e.g., an mvhd atom) that defines the timescale and duration information for the entire movie, as well as its display characteristics. The movie atom may also contain a track atom (e.g., a trak atom) for each track in the movie. Each track atom may include one or more media atoms (e.g., an mdia atom) along with other atoms that define other track and movie characteristics. In this tree-like hierarchy, the moov atom may act as an index of the video data. The MPEG-4 muxer may store information about the file in the moov atom to enable the viewer to play and scrub the file as well. The file may not start to play until the player can access this index.

Unless specified otherwise, the moov atom may be stored at the end of the file in on-demand content, after all of the information describing the file has been generated. Depending on the type of on demand delivery technique selected (e.g., progressive download, streaming, or local playback), the location may be moved either to the end or to the beginning of the file.

If the planned delivery technique is progressive download or streaming (e.g., Real-Time Messaging Protocol (RTMP) or Hypertext Transfer Protocol (HTTP)), the moov atom may be moved to the beginning of the file. This ensures that the needed movie information may be downloaded first, enabling playback to start. If the moov atom is located at the end of the file, the entire file may need to be downloaded before the beginning of playback. If the file is intended for local playback, then the location of the moov atom may not impact the start time, since the entire file is available for playback. The placement of the moov atom may be specified in various software packages through settings such as “progressive download,” “fast start,” “use streaming mode,” or similar options. In this regard,

[symbol]

Using the duration information, heuristics may be used to parse whether the container includes music video or cinematic content. Further, the number of channels used may be determined from the decoder audio (e.g., channel configuration parameters).

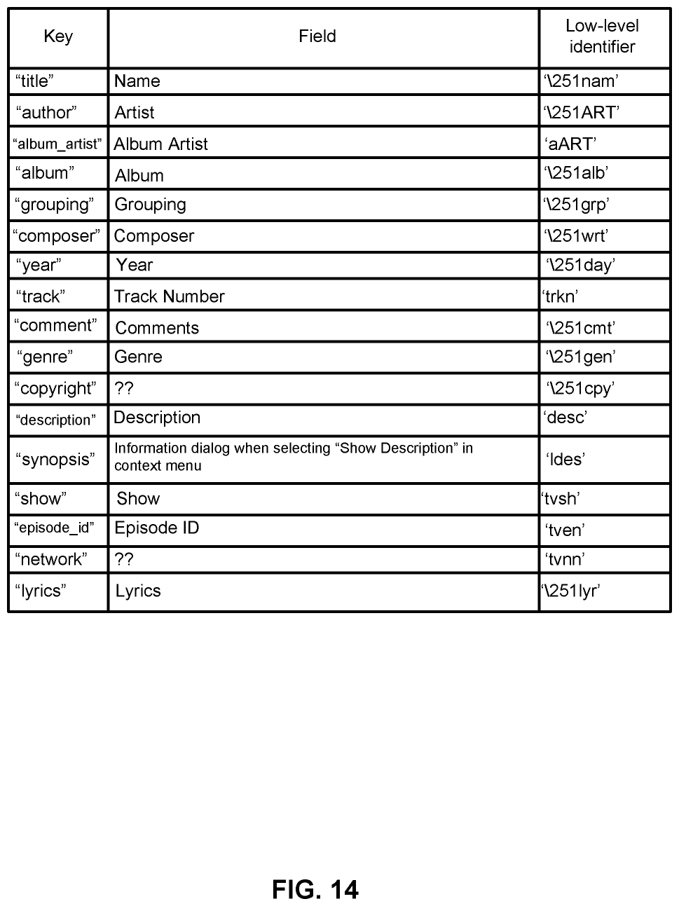

According to an example, the MP-4 file-format may be used to discriminate between cinematic content and long-duration music content (e.g., live-concert audio-video recordings) using Object Content Information (OCI) which provides meta-information about objects. Object Content Information may define a set of descriptors and a stream type that have been defined in MPEG-4 Systems to carry information about the media object in general: Object Content Information descriptors and Object Content Information streams. Accordingly, a ContentClassificationDescriptor tag may be used by the creator or distributor, prior to encoding, for classification of the genre of the content. In this regard, FIG. 14 illustrates an example of MP-4 metadata, where the metadata field may be extracted.

Voice in cinematic multichannel content may be located in the center channel and may be manipulated accordingly in terms of its preset. For business communications, voice/speech may be mono and a decoder output may trigger the appropriate preset.

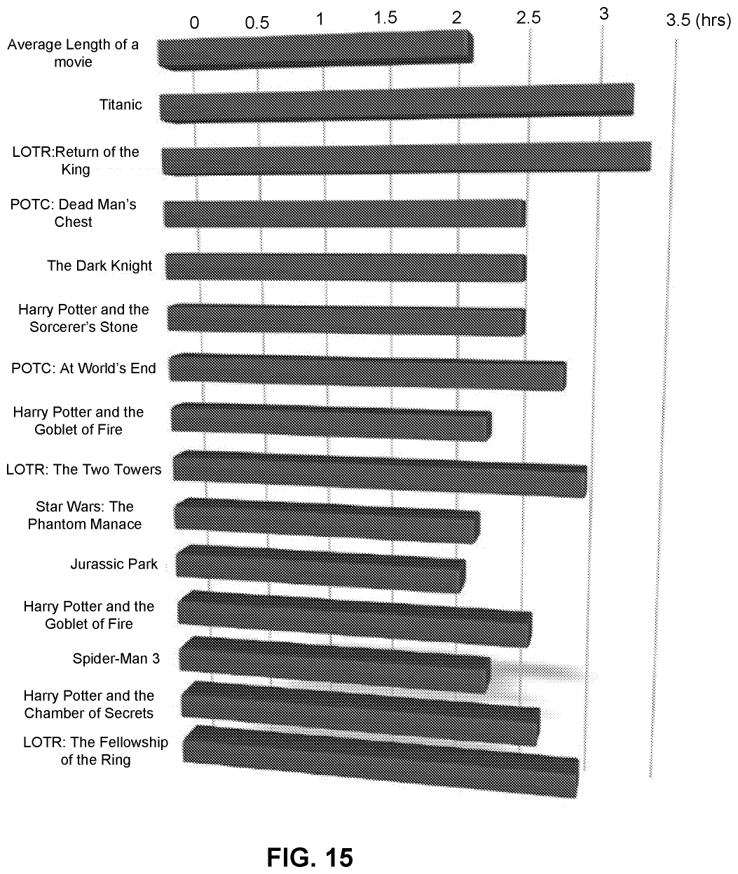

With respect to content duration, statistics of feature film length and music video statistics may be obtained or derived from analysis. For example, FIG. 15 illustrates an example of average duration of movie content along with some specific movies. In this regard, FIG. 15 shows statistics of film length. From FIG. 15, the minimum average duration of cinematic content may be determined to be approximately 120 minutes.

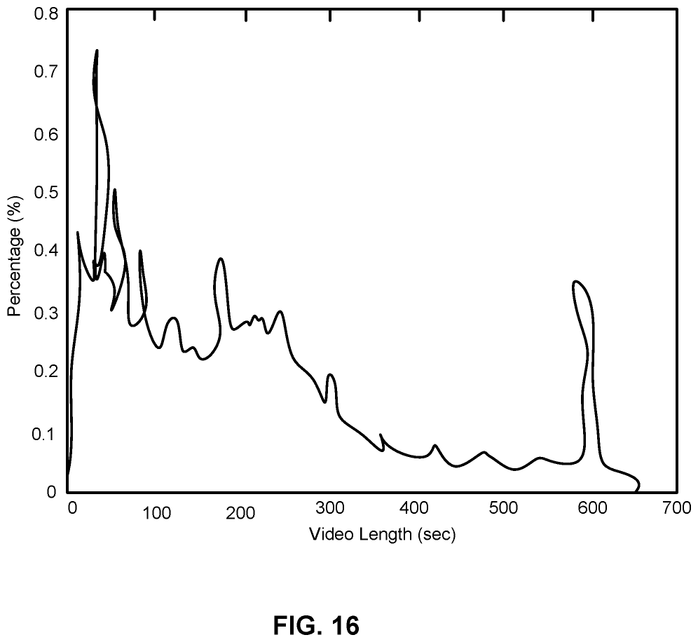

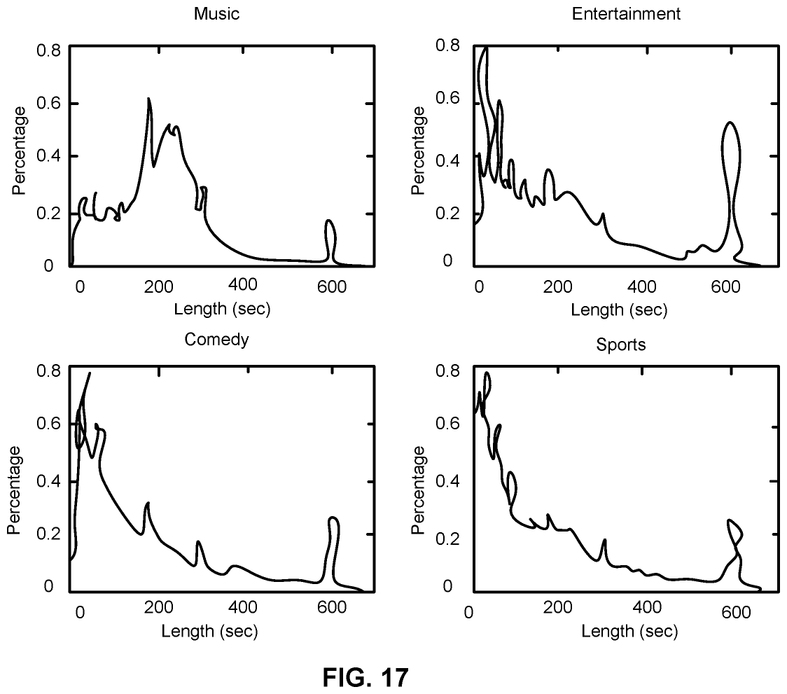

FIG. 16 illustrates an example distribution of a video length. Further, FIG. 17 illustrates examples of distribution of various genres in seconds.

Referring to FIGS. 16 and 17, the statistics of music video files exhibit substantially smaller duration on an average.

The techniques disclosed herein to discriminate between multichannel cinematic (movie) content, stereo music, stereo downmixed movie, and other content based on transport streams, audio coding schemes, container formats, and parsing duration information may be used to apply specific genre tunings as disclosed herein.

With respect to preset selection and adaptation, based on the identification of the content genre, appropriate tuning presets may be applied to the content. According to examples, the presets may include the stereo music preset (e.g., for non-video and video-based music), voice preset (e.g., for entertainment), and movie preset (e.g., for stereo downmix). Additionally a fourth preset may be applied for multichannel, or next-generation audio (e.g., object-based audio or higher-order ambisonic based audio) for cinematic and entertainment content.

With respect to design and integration in personal devices, the techniques disclosed herein may be integrated, for example, in the any type of processors.

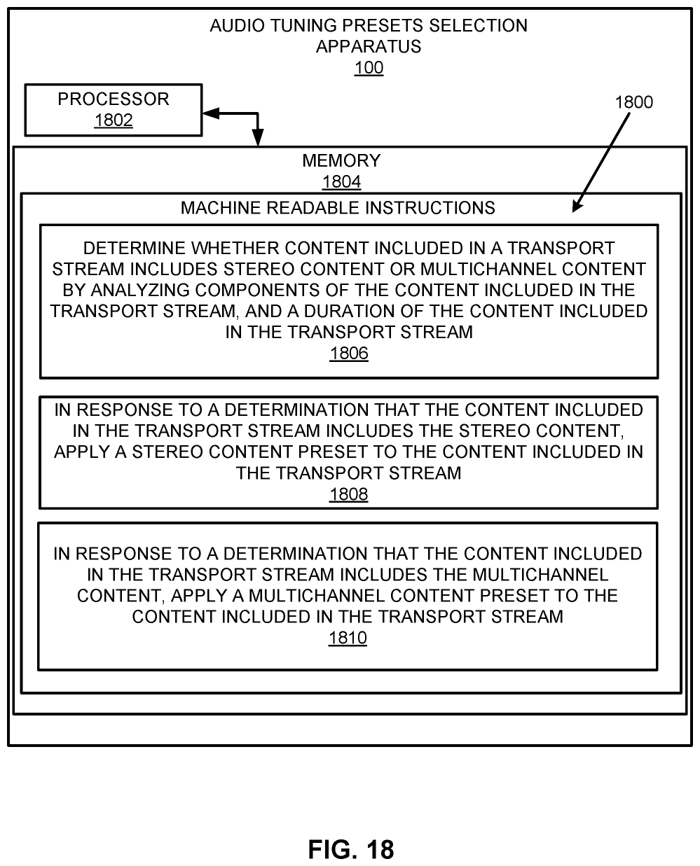

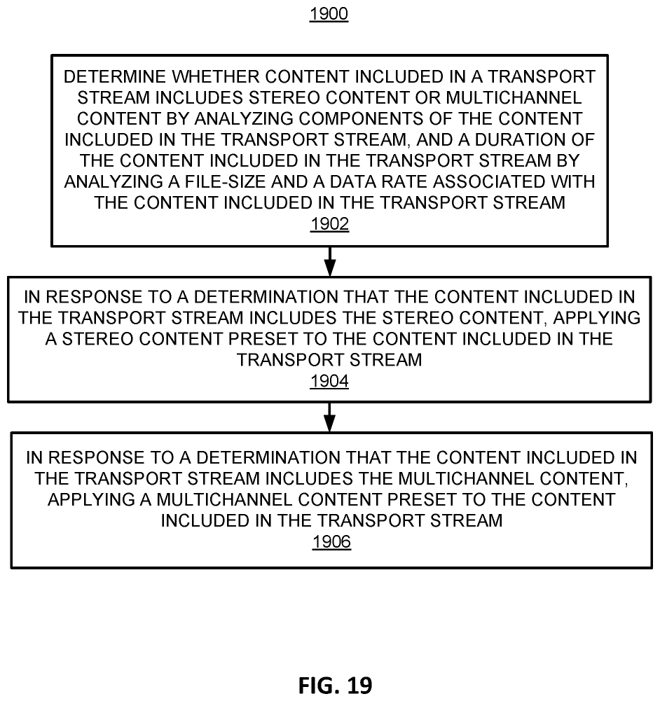

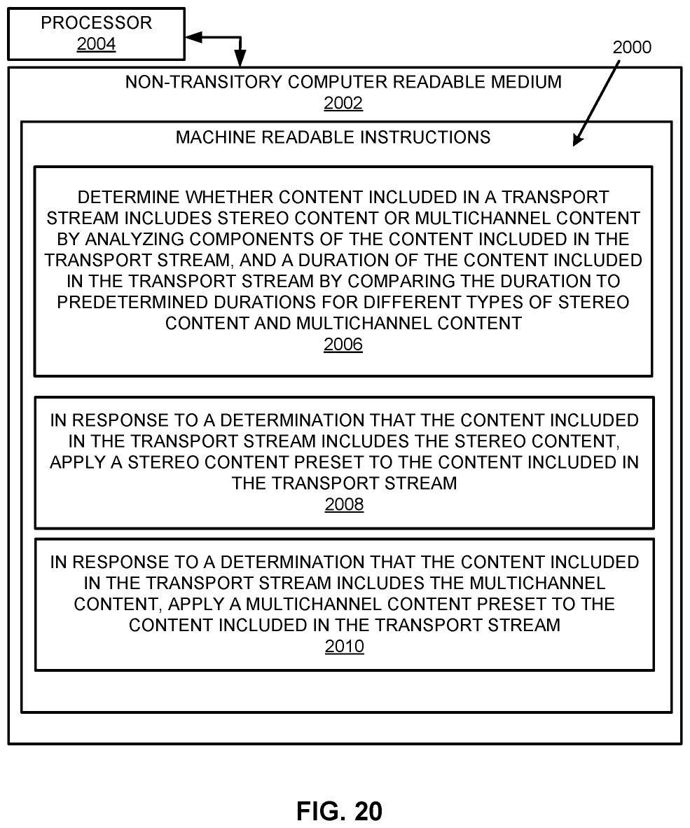

FIGS. 18-20 respectively illustrate an example block diagram 1800, an example flowchart of a method 1900, and a further example block diagram 2000 for audio tuning presets selection. The block diagram 1800, the method 1900, and the block diagram 2000 may be implemented on the apparatus 100 described above with reference to FIG. 1 by way of example and not limitation. The block diagram 1800, the method 1900, and the block diagram 2000 may be practiced in other apparatus. In addition to showing the block diagram 1800, FIG. 18 shows hardware of the apparatus 100 that may execute the instructions of the block diagram 1800. The hardware may include a processor 1802, and a memory 1804 (i.e., a non-transitory computer readable medium) storing machine readable instructions that when executed by the processor cause the processor to perform the instructions of the block diagram 1800. The memory 1804 may represent a non-transitory computer readable medium. FIG. 19 may represent a method for audio tuning presets selection, and the steps of the method. FIG. 20 may represent a non-transitory computer readable medium 2002 having stored thereon machine readable instructions to provide audio tuning presets selection. The machine readable instructions, when executed, cause a processor 2004 to perform the instructions of the block diagram 2000 also shown in FIG. 20.

The processor 1802 of FIG. 18 and/or the processor 2004 of FIG. 20 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 2002 of FIG. 20), such as hardware storage devices (e.g., RAM (random access memory), ROM (read only memory), EPROM (erasable, programmable ROM), EEPROM (electrically erasable, programmable ROM), hard drives, and flash memory). The memory 1804 may include a RAM, where the machine readable instructions and data for a processor may reside during runtime.

Referring to FIGS. 1-18, and particularly to the block diagram 1800 shown in FIG. 18, the memory 1804 may include instructions 1806 to determine whether content 104 included in a transport stream 106 includes stereo content 108 or multichannel content 110 by analyzing components 112 of the content 104 included in the transport stream 106, and a duration 114 of the content 104 included in the transport stream 106. For example, the analysis may include an analysis of a duration of the content extracted from the presentation timestamp (PTS) metadata field at the beginning and at the end of the content, with the presentation timestamp being included in the transport stream.

The processor 1802 may fetch, decode, and execute the instructions 1808 to, in response to a determination that the content 104 included in the transport stream 106 includes the stereo content 108, apply a stereo content preset 120 to the content 104 included in the transport stream 106.

The processor 1802 may fetch, decode, and execute the instructions 1810 to, in response to a determination that the content 104 included in the transport stream 106 includes the multichannel content 110, apply a multichannel content preset 122 to the content 104 included in the transport stream 106.

Referring to FIGS. 1-17 and 19, and particularly FIG. 19, for the method 1900, at block 1902, the method may include determining whether content 104 included in a transport stream 106 includes stereo content 108 or multichannel content 110 by analyzing components 112 of the content 104 included in the transport stream 106, and a duration 114 of the content 104 included in the transport stream 106 by analyzing a file-size and a data rate associated with the content 104 included in the transport stream 106. Other techniques including determining the duration from the timestamp may be used.

At block 1904, in response to a determination that the content 104 included in the transport stream 106 includes the stereo content 108, the method may include applying a stereo content preset 120 to the content 104 included in the transport stream 106.

At block 1906, in response to a determination that the content 104 included in the transport stream 106 includes the multichannel content 110, the method may include applying a multichannel content preset 122 to the content 104 included in the transport stream 106.

Referring to FIGS. 1-17 and 20, and particularly FIG. 20, for the block diagram 2000, the non-transitory computer readable medium 2002 may include instructions 2006 to determine whether content 104 included in a transport stream 106 includes stereo content 108 or multichannel content 110 by analyzing components 112 of the content 104 included in the transport stream 106, and a duration 114 of the content 104 included in the transport stream 106 by comparing the duration 114 to predetermined durations for different types of stereo content 108 and multichannel content 110.

The processor 2004 may fetch, decode, and execute the instructions 2008 to, in response to a determination that the content 104 included in the transport stream 106 includes the stereo content 108, apply a stereo content preset 120 to the content 104 included in the transport stream 106.

The processor 2004 may fetch, decode, and execute the instructions 2010 to, in response to a determination that the content 104 included in the transport stream 106 includes the multichannel content 110, apply a multichannel content preset 122 to the content 104 included in the transport stream 106.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium storing machine readable instructions that when executed by the processor cause the processor to:
determine whether content included in a transport stream includes stereo content or multichannel content by analyzing
components of the content included in the transport stream, and
a duration of the content included in the transport stream, wherein the components of the content included in the transport stream are included in a container included in the transport stream;
in response to a determination that the content included in the transport stream includes the stereo content, apply a stereo content preset to the content included in the transport stream; and
in response to a determination that the content included in the transport stream includes the multichannel content, apply a multichannel content preset to the content included in the transport stream.

2. The apparatus according to claim 1, wherein for the stereo content, the instructions are further to cause the processor to:
determine whether the stereo content includes a video, whether the stereo content does not include the video, and whether the stereo content is downmixed cinematic content; and
in response to a determination that the stereo content includes the video, that the stereo content does not include the video, or that the stereo content is downmixed cinematic content, apply a corresponding type of the stereo content preset to the content included in the transport stream.

3. The apparatus according to claim 1, the instructions are further to cause the processor to:
determine whether the content included in the transport stream includes voice in Voice over Internet Protocol (VoIP), or speech; and
in response to a determination that the content included in the transport stream includes the voice in VoIP, or the speech, apply a voice preset to the content included in the transport stream.

4. The apparatus according to claim 1, wherein the instructions are further to cause the processor to:
determine whether the content included in the transport stream includes microphone-captured speech; and
in response to a determination that the content included in the transport stream includes the microphone-captured speech, apply a microphone-captured speech voice preset to the content included in the transport stream.

5. The apparatus according to claim 1, wherein the instructions are further to cause the processor to:
determine, based on the analysis of the components in a Program Map table included in the container, whether the content included in the transport stream includes audio content, or audio and video content, wherein the components include audio frames for the audio content; and
in response to a determination that the content included in the transport stream includes the audio content, or the audio and video content, selectively apply the stereo content preset or the multichannel content preset to the content included in the transport stream.

6. The apparatus according to claim 1, wherein the instructions are further to cause the processor to:
determine, based on the analysis of the components in a Program Map table included in the container, whether the content included in the transport stream includes audio content, or audio-for-video content; and
in response to a determination that the content included in the transport stream includes the audio content, or the audio-for-video content, selectively apply the stereo content preset or the multichannel content preset to the content included in the transport stream.

7. The apparatus according to claim 1, wherein the instructions are further to cause the processor to:
determine the duration of the content included in the transport stream by analyzing a file-size and a data rate associated with the content included in the transport stream.

8. The apparatus according to claim 7, wherein the data rate includes a constant bitrate or a variable bitrate.

9. The apparatus according to claim 1, wherein the instructions are further to cause the processor to:
analyze the duration of the content included in the transport stream by comparing the duration to predetermined durations for different types of stereo content and multichannel content.

10. A method comprising:
determining, by a processor, whether content included in a transport stream includes stereo content or multichannel content by analyzing
components of the content included in the transport stream, and
a duration of the content included in the transport stream, wherein
the duration is analyzed by analyzing a file-size and a data rate associated with the content included in the transport stream, and
the components of the content included in the transport stream are included in a container included in the transport stream;
in response to a determination that the content included in the transport stream includes the stereo content, applying a stereo content preset to the content included in the transport stream; and
in response to a determination that the content included in the transport stream includes the multichannel content, applying a multichannel content preset to the content included in the transport stream.

11. The method according to claim 10, wherein the components of the content included in the transport stream include an audio coding scheme that specifies a type of the content included in the transport stream.

12. The method according to claim 10, wherein the components of the content included in the transport stream include a container format that is used to determine whether the content included in the transport stream includes the stereo content or the multichannel content.

13. A non-transitory computer readable medium having stored thereon machine readable instructions, the machine readable instructions, when executed, cause a processor to:
determine whether content included in a transport stream includes stereo content or multichannel content by analyzing
components of the content included in the transport stream, and
a duration of the content included in the transport stream, wherein
the duration is analyzed by comparing the duration to predetermined durations for different types of stereo content and multichannel content;
in response to a determination that the content included in the transport stream includes the stereo content, apply a stereo content preset to the content included in the transport stream; and
in response to a determination that the content included in the transport stream includes the multichannel content, apply a multichannel content preset to the content included in the transport stream.

14. The non-transitory computer readable medium according to claim 13, wherein the instructions are further to cause the processor to:
determine, based on the analysis of the components in a Program Map table included in a container included in the transport stream, whether the content included in the transport stream includes audio content, or audio and video content, wherein the components include audio frames for the audio content; and
in response to a determination that the content included in the transport stream includes the audio content, or the audio and video content, selectively apply the stereo content preset or the multichannel content preset to the content included in the transport stream.

15. The non-transitory computer readable medium according to claim 13, wherein the instructions are further to cause the processor to:
determine, based on the analysis of the components in a Program Map table included in a container included in the transport stream, whether the content included in the transport stream includes audio content, or audio-for-video content; and
in response to a determination that the content included in the transport stream includes the audio content, or the audio-for-video content, selectively apply the stereo content preset or the multichannel content preset to the content included in the transport stream.
